(19) United States
(12) Patent Application Publication
(10) Pub. No.: US 2006/0213100 A1
(43) Pub. Date: Sep. 28, 2006

(54) Electronic display system

(76) Inventor: Keith H. McCann, Louisville, KY (US)

Correspondence Address: LITMAN LAW OFFICES, LTD, PO BOX 15035, CRYSTAL CITY STATION, ARLINGTON, VA, 22215, US

(21) Appl. No.: 11/312,565

(22) Filed: Dec. 21, 2005

Related U.S. Application Data
(60) Provisional application No. 60/637,454, filed on Dec. 21, 2004.

(51) Int. Cl. G09F 21/04

(52) U.S. Cl. 40/591

(57) ABSTRACT

The electronic display system displays advertisements, traffic and weather information on a display panel mounted to the license plate support of an automobile or any vehicle when the vehicle is moving beneath a predetermined threshold speed. The display can be mounted elsewhere, for example, anywhere on the rear or sides of a larger vehicle such as a van, bus or truck, where it will be readily seen. Once the vehicle exceeds the predetermined threshold speed, the display changes, showing vehicle license plate information, such as the license plate number, State of registration, etc. The electronic display system includes a programmable electronic display, driven by a display driver, and an electronic control module that allows information to be sent to and shown on the electronic display. The electronic control module is coupled to a speedometer, a tachometer, or a sensor that determines the rate at which the drive shaft rotates, which allows the control module to determine whether the threshold speed has been reached.

### CROSS-REFERENCE TO RELATED APPLICATION

This application claims the benefit of U.S. Provisional Patent Application Ser. No. 60/637,454, filed Dec. 21, 2004.

### BACKGROUND OF THE INVENTION

1. Field of the Invention

The present invention relates to a display device for a motor vehicle, and particularly to an electronic display system for displaying information that can be reprogrammed, and that may include advertising or other commercial notices.

2. Description of the Related Art

Conventional license plates for conveying vehicle identification are well known. License plates including some form of electronic device for illuminating at least a portion of the display area of the plate and information display devices mounted onto automobiles, such as buses, are also known. Further, bumpers of cars, windows, etc. often bear signs used to display the vehicle owner's preference for political candidates or causes, for places to vacation, or for favored establishments. Some plate displays allow for advertising of the owner's school or the vehicle's dealership on license plate frames that surround the actual license plate itself. Of course, displays are not limited to the vehicle license plates, but can be anywhere on the sides (in the case of a bus, for example), or rear of a vehicle, and the present invention encompasses displays anywhere on the vehicle sides or rear. However, such conventional plates, signs, or display devices for vehicles typically display an invariable message or image, except for the roof-mounted billboard kind of sign frequently displayed on taxi cabs and other commercial vehicles, which require manual replacement of a paper sign mounted within the billboard frame.

Such advertisements and other displays may only be permanently fixed on the car or displayed around the edge of the license plate. Further, as these displays are fixed, new or real-time information may not be shown on the automobile. Additionally, drivers are often stuck in traffic for long periods of time or stopped at intersections and are forced to view the same standard advertisements or vehicle identity information displayed on the automobile.

For example, United Kingdom patent GB 2 183 383, dated June 1987, discloses a flashing advertising sign using fluorescent light sources, however the advertisement is on a transparency and must be manually changed to change the displayed ad. Additionally, WIPO PCT patent WO 96/36030, dated November 1996, discloses an electronic license plate system with an ID device embedded in the plate, however does not disclose nor suggest a display having information that changes in real-time and according to a predetermined threshold vehicle speed. Similarly, WIPO PCT patent WO 99/19170, dated April 1999, only appears to disclose a license plate with a readable electronic data carrier which can be read without contact, and unlike the present invention, does not appear to disclose nor suggest a display having information that changes in real-time and according to a predetermined threshold vehicle speed. Moreover, German patent DE 10062168, dated June 2002, appears to disclose an advertising sign having a display element formed by an electrically activated polymer foil, but appears not to disclose nor suggest a display having information that changes in real-time and according to a predetermined threshold vehicle speed.

Accordingly, there is a need for an electronic display system that permits a variety of information to be displayed on an automobile and that permits new, real-time information to be transmitted to the system, stored and displayed. Thus, an electronic display system solving the aforementioned problems is desired.

### SUMMARY OF THE INVENTION

The electronic display system displays advertisements, traffic and weather information on a display panel mounted to the license plate support of an automobile or any vehicle. The display can be mounted elsewhere, for example, anywhere on the rear of a larger vehicle such as a van, bus or truck, where it will be readily seen. Once the vehicle exceeds the predetermined threshold speed for a set amount of time, the display changes, showing vehicle license plate information, such as the license plate number and name of the State in which the vehicle is registered.

The electronic display system includes a programmable electronic display, driven by an electronic display driver, and an electronic control module that allows information to be sent to and shown on the electronic display. The electronic control module is coupled either to the vehicle's speedometer, to a tachometer either coupled to the driveshaft instead of the crankshaft or when a brake sensor determines that the brake is released, or to a sensor that determines the rate at which the driveshaft rotates, which allows the control module to determine whether a threshold speed has been reached.

Once the electronic control module determines that a specific threshold speed has been reached, the vehicle identity information, stored within the electronic control module, is transmitted to, and shown upon, the display. The electronic control module may be directly connected to the display driver. The control module optionally may be connected to a transmitter/receiver, and the display driver optionally may be coupled to a receiver. The module may then send information wirelessly to the display driver.

If the electronic control module determines that the vehicle is moving below the threshold speed, a second set of information, which may include advertisements, traffic and weather information, is then transmitted to the display driver to be shown on the display. The second set of information may either be stored in the control module, may be wirelessly transmitted to the control module from an outside source, or may be wirelessly transmitted directly to the display driver's receiver from an outside source.

Thus, advertisements and other information may be displayed when the vehicle is not moving or is moving slowly in congested traffic areas, while vehicle identity information will be displayed when the automobile is moving at a higher speed.

In an alternative embodiment, the electronic display system need not be placed on a license plate support, but may be mounted anywhere upon the vehicle, e.g., in or on the rear window, on the roof, etc. In this case, the display will not show the vehicle tag number. Rather, the display presents a first message when the vehicle is not moving, or is moving below a specified speed for a predetermined period of time. The first message may be an advertisement, weather information, or any other desired information, and may be presented in either a static or a dynamic or streaming display. The first message may be stored in memory in the control module, or received by wireless transmission.

In this embodiment, once the electronic control module determines that a threshold speed is reached and a predetermined time delay has occurred, a second message is displayed, or the display may freeze on the currently displayed advertisement in the case of a dynamic display, or the display may be blanked.

These and other features of the present invention will become readily apparent upon further review of the following specification and drawings.

### BRIEF DESCRIPTION OF THE DRAWINGS

FIG. 1 is a block diagram of the electronic display system according to the present invention.

FIG. 2 is an environmental, perspective view of vehicle registration information being displayed upon the electronic display of the electronic display system according to the present invention.

FIG. 3 is an environmental, perspective view of an exemplary commercial or public service message displayed upon the electronic display of the electronic display system according to the present invention.

Similar reference characters denote corresponding features consistently throughout the attached drawings.

### DETAILED DESCRIPTION OF THE PREFERRED EMBODIMENT

The present invention is an electronic display system, designated generally as 10 in the drawings, that generally displays rotating advertisements or the like until a predetermined threshold speed is exceeded. Once the threshold speed of the vehicle is exceeded, an electronic display alternatively displays vehicle license plate information, such as the license plate number and State in which the vehicle is registered.

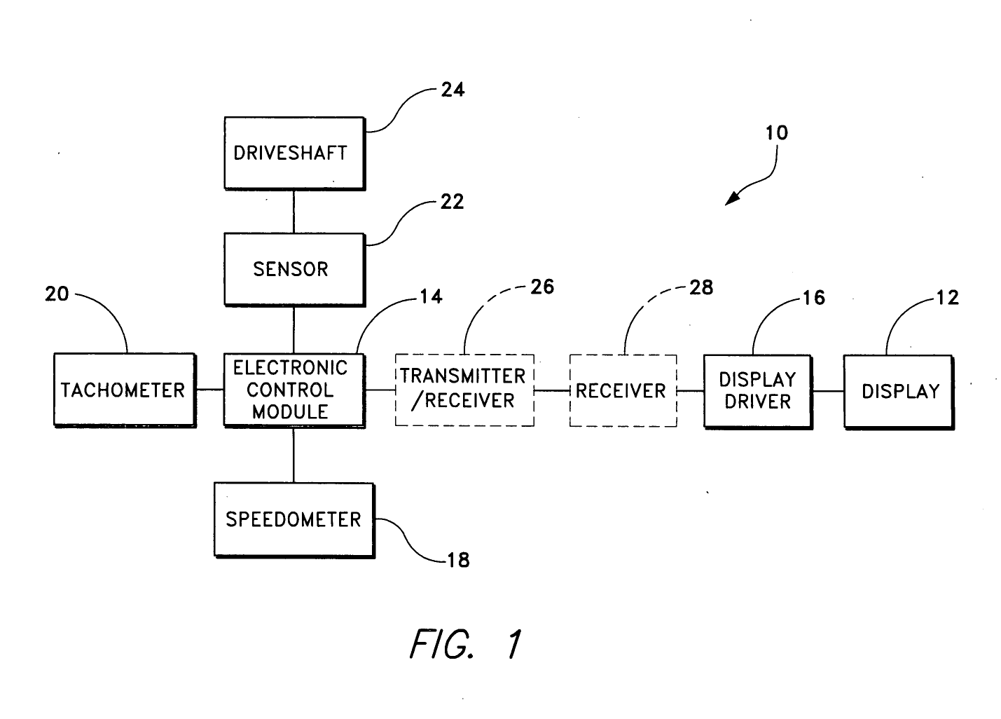

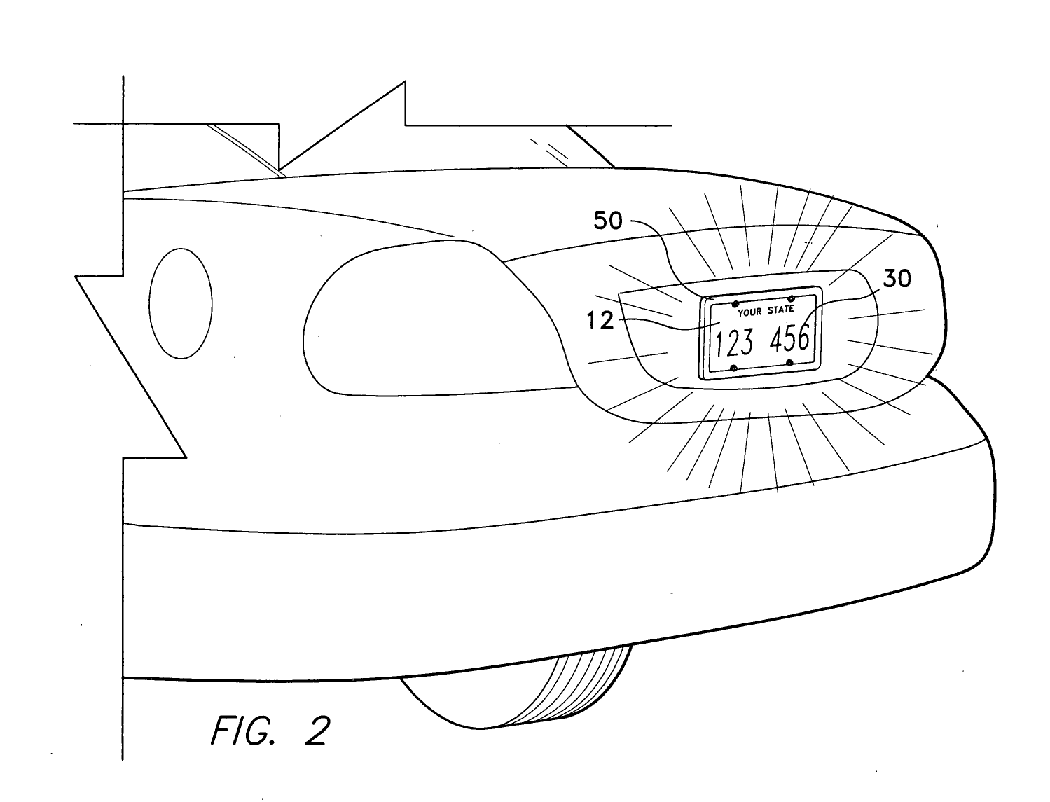

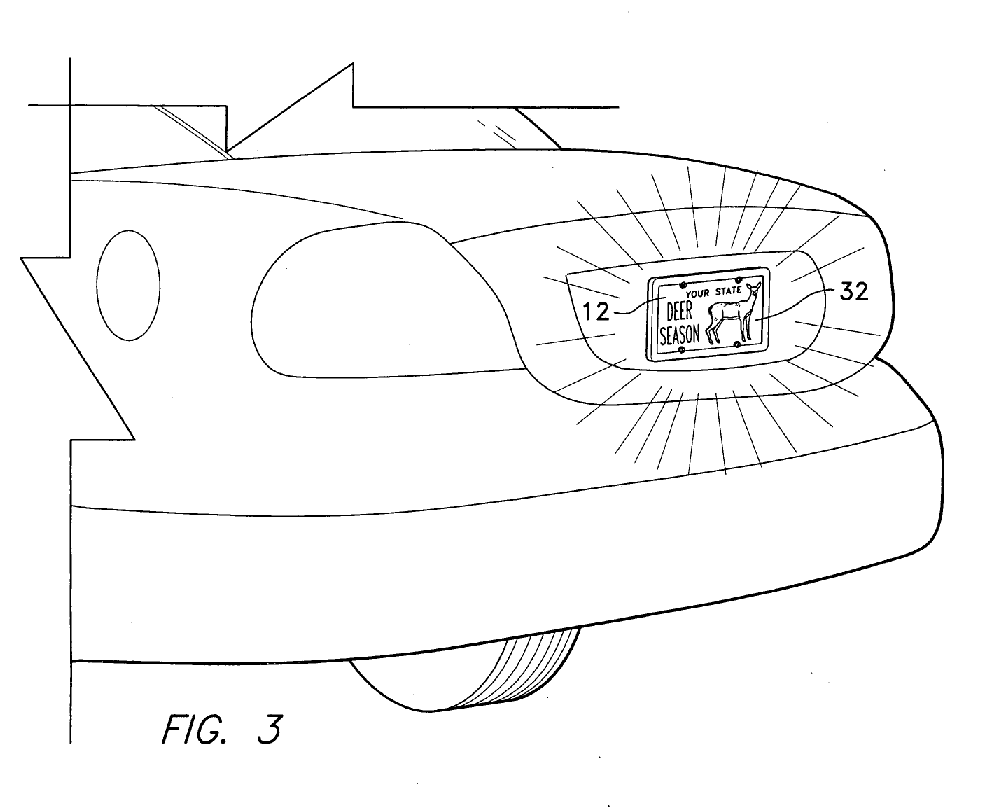

Referring first to FIG. 1, a block diagram of the electronic display system 10 is shown. The electronic display system 10 includes a programmable electronic display 12 and an electronic control module 14 that allows information to be sent to and shown on the electronic display 12. The electronic display 12 may be a liquid crystal display, an LED display, or any other electronic display device that can show text, graphics, images or the like. The electronic display 12 is generally mounted either to the front or back of a vehicle, and preferably is mounted to a license plate support, such as the frame 50 shown in FIGS. 2 and 3, although the display 12 may be mounted directly to the plate-mounting bosses. The electronic display 12 is driven by a display driver 16. The display driver 16 is connected to the electronic control module 14 that sends an output signal to the display driver 16 for displaying the appropriate image on electronic display 12. Alternatively, the display driver 16 may be integral with the electronic control module 14. The electronic control module 14 is coupled either to the vehicle speedometer 18, to a tachometer 20 coupled to the driveshaft 24 instead of the crankshaft, or to a sensor 22 that determines the rate at which the driveshaft 24 rotates, which allows the control module 14 to determine whether a threshold speed has been reached.

Either the electronic control module 14 may be directly connected to the display driver 16 or the control module 14 may be connected to a transmitter/receiver 26. In the latter case, the display driver 16 may be coupled to a receiver 28. Control signals may be sent wirelessly by the transmitter/receiver 26 to the receiver 28, thus providing the wireless transmission of information.

Turning now to FIGS. 2 and 3, vehicle registration information 30 is shown on the electronic display 12. The vehicle registration information 30 may include the vehicle license plate or tag number, the State, territory, country, or jurisdiction in which the vehicle is registered, and any other vehicle identity information necessary for compliance with traffic laws and regulations. A registration renewal sticker may be affixed to a corner of the display 12 or an adjacent area of the vehicle. The vehicle registration information 30 is displayed when the vehicle is moving above a predetermined threshold speed. This vehicle registration information 30 is stored within the electronic control module 14 and transmitted to the display 12 once the threshold speed has been reached. The electronic control module 14 reads the speedometer 18, or a tachometer 20 either attached to the driveshaft 24 instead of the crankshaft or when a brake sensor also senses that the brake is released, to ascertain the speed of the vehicle. Alternatively, the control module 14 may determine the speed of the vehicle through the sensor 22 attached to the driveshaft 24. While three methods of determining the speed of the vehicle are shown, any other method that may determine a specific speed may also be employed.

Turning back to FIG. 1, once the electronic control module 14 determines that the vehicle is moving below the predetermined threshold speed, information is transmitted to the display 12, which displays information 32 that may be programmed from memory or from a wireless source containing content that may be commercial, news, weather, traffic, public service, or any other desired nature. The information 32 may be preprogrammed advertisements or weather or traffic information loaded into the electronic control module 14. The weather or traffic information may be transmitted to the transmitter/receiver 26 connected to the control module 14, where the weather or traffic information could be stored, then sent to the receiver 28 attached to the display driver 16. The weather or traffic information 32 may alternatively be predetermined control signals sent directly to the receiver 28 coupled to the display driver 16 so that road traffic agencies or the like are able to provide accurate, real-time information.

The predetermined speed is generally the speed at which it is apparent that the vehicle is moving in traffic congestion. Therefore, when the vehicle is moving quickly, the electronic display system 10 allows for the vehicle license plate information to be displayed. When the vehicle is moving slowly due to traffic congestion or is stopped, the display 12 shows a preprogrammed or transmitted advertisements, weather or traffic information. Thus, automobile drivers sitting behind the user's vehicle in traffic or at a stoplight will be able to view the advertised information.

The electronic display system 10 is powered using the vehicle's existing power system. The electronic display system 10 may be used with any type of road vehicle.

In an alternative embodiment, the electronic display system need not be placed on a license plate support, but may be mounted anywhere upon the vehicle, e.g., in or on the rear window, on the roof, etc. In this case, the display will not show the vehicle tag number. Rather, the display presents a first message when the vehicle is not moving, or is moving below a specified speed for a predetermined period of time. The first message may be an advertisement, weather information, or any other desired information, and may be presented in either a static or a dynamic or streaming display. The first message may be stored in memory in the control module, or received by wireless transmission.

In this embodiment, once the electronic control module determines that a threshold speed is reached and a predetermined time delay has occurred, a second message is displayed, or the display may freeze on the currently displayed advertisement in the case of a dynamic display, or the display may be blanked.

It is to be understood that the present invention is not limited to the embodiment described above, but encompasses any and all embodiments within the scope of the following claims.

I claim:

1. An electronic display system for use with a vehicle, comprising: electronic display means for displaying information, the display means being adapted for mounting on a vehicle;
an electronic control module connected to the display means; and
means for detecting a predetermined threshold speed of the vehicle, the means for detecting the threshold speed being electrically connected to the electronic control module;
wherein the electronic display means displays vehicle registration information when the predetermined threshold speed is exceeded, and programmed content information when vehicle speed is less than the threshold speed.

2. An electronic display system for use with a vehicle, comprising:
a programmable electronic display having an adaptation for mounting on a vehicle;
an electronic control module having a connection to the programmable electronic display;
the electronic control module further alternatively having a connection to a tachometer, a speedometer, and a sensor wherein the control module has the capability to determine whether a predetermined threshold speed has been reached;
the sensor having a connection to a driveshaft of the vehicle to determine a rate at which the driveshaft rotates;
vehicle registration and programmed content information available for transmission of the information to the display;
wherein alternatively, the programmable electronic display displays the vehicle registration information when the predetermined threshold speed is exceeded, and the programmed content information when vehicle speed is less than the threshold speed.

3. The electronic display system according to claim 2, wherein the electronic control module connection to the programmable electronic display further comprises a connection to a display driver so that an output signal for displaying an image can be sent by the electronic control module to the display driver for displaying the image on the electronic display.

4. The electronic display system according to claim 3, wherein the display driver is integral with the electronic control module.

5. The electronic display system according to claim 2, wherein the connection to the tachometer comprises a tachometer coupling to the driveshaft instead of a crankshaft.

6. The electronic display system according to claim 3, wherein the connection to the display driver further comprises a connection of the electronic control module to a transmitter/receiver.

7. The electronic display system according to claim 6, wherein the display driver may be coupled to a receiver.

8. The electronic display system according to claim 7, further comprising: the capability of sending control signals wirelessly by the transmitter/receiver to the receiver, wherein the wireless transmission of information is provided.

9. The electronic display system according to claim 2, wherein the vehicle registration information includes a vehicle license plate number, a jurisdiction in which the vehicle is registered, and any other vehicle identity information necessary for compliance with traffic laws and regulations.

10. The electronic display system according to claim 2, wherein the vehicle registration information is stored within the electronic control module.

11. The electronic display system according to claim 2, wherein the capability to determine whether a threshold speed has been reached further comprises having the capability to ascertain the speed of the vehicle.

12. The electronic display system according to claim 2, wherein the programmed content information is stored within the electronic control module.

13. The electronic display system according to claim 2, wherein the programmed content information is made available from a wireless source.

14. The electronic display system according to claim 2, wherein the programmed content information may include commercials, news, weather, traffic, and public service.

15. The electronic display system according to claim 14, wherein the programmed content information may include preprogrammed advertisements, weather, traffic information loaded into the electronic control module.

16. The electronic display system according to claim 15, wherein the preprogrammed weather, traffic information may be transmitted to the transmitter/receiver for storage and forwarding to the receiver.

17. The electronic display system according to claim 15, wherein the weather, traffic information is sent directly in real-time to the receiver from an outside agency.

18. The electronic display system according to claim 2, wherein the predetermined threshold speed is a speed at which it is apparent that the vehicle is moving in traffic congestion.

19. The electronic display system according to claim 2, wherein the system is powered using the vehicle's existing power system.

20. An electronic display system for use with a vehicle, comprising:
electronic display means for displaying information, the display means being adapted for mounting on a vehicle;
an electronic control module connected to the display means; and
means for detecting a predetermined threshold speed of the vehicle, the means for detecting the threshold speed being electrically connected to the electronic control module;
wherein the electronic display means displays a first message when vehicle speed is less than the threshold speed, and a second message when vehicle speed is greater than the predetermined threshold speed.
